(19) United States
(12) Patent Application Publication
(10) Pub. No.: US 2007/0284194 A1
(43) Pub. Date: Dec. 13, 2007

(54) Stairlifts

(76) Inventor: Max D. Woodhams, Hants (GB)

Correspondence Address: GRAY, PLANT, MOOTY, MOOTY & BENNETT, P.A., P.O. BOX 2906, MINNEAPOLIS, MN, 55402-0906, US

(21) Appl. No.: 10/590,447

(22) PCT Filed: Mar. 2, 2005
(86) PCT No.: PCT/GB05/00763

§ 371 Date: Apr. 24, 2007

(30) Foreign Application Priority Data
Mar. 2, 2004 (GB) 0404644.7

(51) Int. Cl. B66B 9/08

(52) U.S. Cl. 187/202

(57) ABSTRACT

The invention provides a single component footrest for a stairlift chair which is configured, and mounted to pivot about a substantially vertical axis, to allow clearance to be achieved regardless of the stairlift installation.

### FIELD OF THE INVENTION

This invention relates to stairlifts and, in particular, to a footrest for use with a stairlift chair.

### BACKGROUND TO THE INVENTION

A footrest is an integral part of a stairlift chair. However, in the past, there have been instances in which the need to provide a footrest has lead to significant difficulties when effecting a particular installation. As the footrest is the closest component of the chair to the staircase, difficulties are often encountered providing clearance between the footrest and the staircase, at all positions of the stairlift chair along the stairlift rail. Interference between the footrest and the staircase is most commonly encountered where the staircase changes direction, but may also be encountered in other positions depending on the configuration of the staircase.

In the past some stairlift installations have required the centreline of the footrest to be off-set from the centreline of the chair by a considerable distance in order to achieve the necessary clearance. In other installations the side edges of the (nominally) rectangular footrest have to be cut back at an angle to provide clearance with the staircase.

The different problems encountered, and the fact a stairlift installation may be right-handed or left-handed, mean that a variety of footrest configurations must be manufactured. This has undesirable cost and inventory implications. Furthermore, a technician installing a stairlift may have to take a variety of different footrests to site and decide, when completing the installation, which particular configuration offers the best compromise between passenger comfort, and the need to provide operating clearance between the stairlift and the staircase.

It is an object of the invention to provide a footrest for a stairlift chair which will go at least some way in addressing the aforementioned problems; or which will at least provide a novel and useful choice.

### SUMMARY OF THE INVENTION

Accordingly, in a first aspect the invention provides a footrest for a stairlift chair, said footrest including a substantially planar upper surface;

an outer edge;

an inner edge substantially opposed to said outer edge; and

side edges joining respective outer margins of said inner edge and said outer edge,

said footrest being characterised in that said inner edge is shorter than said outer edge and said footrest has a pivot point through which said footrest is in use, pivoted about a substantially vertical axis with respect to said chair, said pivot point being positioned closer to said inner edge than to said outer edge.

Preferably said footrest has a geometric centreline.

Preferably said pivot point lies on said centreline.

Preferably said side edges extend outwardly from said outer edge.

Preferably footrest further includes fixing means to fix the position of said footrest about said pivot point.

In a second aspect the invention provides a stairlift chair having a footrest as set forth above.

In a third aspect the invention provides a stairlift chair and footrest combination, said chair having a central axis extending perpendicular to the intended direction of travel of said chair, and said footrest having a geometric centre line, said footrest further having an outer edge; an inner edge substantially opposed to said outer edge; and side edges joining respective outer margins of said inner edge and said outer edge, said combination being characterised in that the inner edge of said footrest is shorter than said outer edge and said footrest is mounted to pivot with respect to said chair about a substantially vertical axis, the pivot position lying on both the central axis of said chair and the geometric centreline of said footrest.

Preferably said pivot position lies closer to the inner edge of said footrest than to said outer edge.

In a fourth aspect, the invention provides a stairlift including the chair and footrest combination as set forth above.

In a fifth aspect the invention comprises any novel combination of the integers disclosed herein capable of addressing a problem known in the stairlift art.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be limited by the appended claims alone.

### BRIEF DESCRIPTION OF THE DRAWINGS

One preferred form of the invention will now be described with reference to the accompanying drawings in which:

FIG. 1: shows an isometric view of a stairlift chair and footrest according to the invention;

FIG. 2: shows a plan view, in a larger scale, of a footrest according to the invention in a first position; and

FIG. 3: shows a view similar to FIG. 1 but in a second position.

### DETAILED DESCRIPTION OF WORKING EMBODIMENT

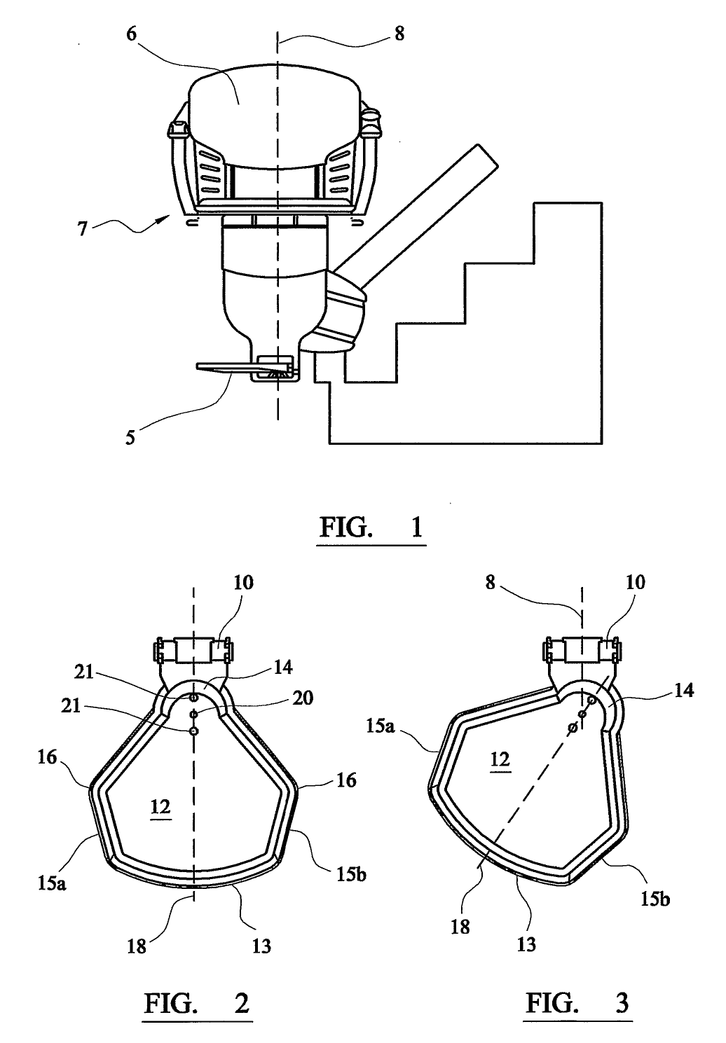

According to the invention a footrest 5 is provided for use with the chair 6 of a stairlift installation 7. The precise form of the chair is not important to the understanding and implementation of the invention. The sole requirement is that the chair 6 have a central axis 8 as shown in FIG. 1

In the form shown in the drawings the footrest 5 is fixed to mounting bracket 10, the bracket 10 being provided at the base of the chair. The bracket 10 is configured to allow the footrest 5 to be folded upwards when the stairlift is not in use.

As can be seen in FIGS. 2 and 3, in the particular form shown, the footrest has a substantially planar upper surface 12, an outer edge 13, an inner edge 14, and two side edges 15a and 15b. It will also be noted that the inner edge 14 is substantially shorter than the outer edge 13, whilst the two side edges 15a, 15b flare outwardly from the margins of the outer edge 13 to a maximum width indicated at 16, before tapering inwardly to the outer margins of the inner edge 14.

It will also be noted that the footrest preferably has a geometric centreline 18 about which the upper surface 12 is symmetrical.

It should be appreciated that the precise shape shown in the drawings, and described herein, is not essential. Modifications in shape may be made without departing from the scope of the invention.

The footrest is fixed to mounting bracket 10 through a vertical pivot 20. As can be seen the pivot 20 is substantially closer to the inner edge 14 than to the outer edge 13. Fixing means such as lock bolts 21 are provided so that the position of the footrest about the pivot, once selected, can be secured.

It will be noted from FIGS. 2 and 3 that the geometric centreline 18 of the footrest passes through pivot 20 and that the pivot 20 is also positioned on a plane, perpendicular to the intended direction of travel of chair 6, extending through the centreline 8 of the chair 6. Thus the chair/footrest combination as described herein, is equally suited for use on left-handed or right-handed installations.

The footrest as herein described has considerable advantages over the prior art in that an installer may, on site, fix the position of the footrest 5 in a manner which not only suits the intended user but also accounts for any obstructions which would cause a conventional footrest to collide with some part of the staircase. Furthermore, the installer is not required to select from a variety of footrest compoundents or adapt an existing footrest. The one component can be tailored for any given situation.

It will thus be appreciated that the present invention provides a simple yet effective form of footrest for a stairlift installation which successfully addresses the problems experienced heretofore.

1-9. (canceled)

10. A footrest for a stairlift chair, the footrest comprising:
a) a substantially planar upper surface;
b) an outer edge;
c) an inner edge substantially opposed to and shorter than the outer edge;
d) side edges joining respective outer margins of the inner edge and the outer edge; and
e) a pivot point positioned closer to the inner edge than to the outer edge and through which the footrest pivots about a substantially vertical axis with respect to the chair.

11. The footrest of claim 10, in which the footrest has a geometric centerline.

12. The footrest of claim 11, in which the pivot point lies on the centerline.

13. The footrest of claim 10, in which the side edges extend outwardly from the outer edge.

14. The footrest of claim 10, further comprising means to fix the position of the footrest about the pivot point.

15. The footrest of claim 10, in combination with a stairlift chair.

16. In combination a stairlift chair and a footrest, the chair comprising a central axis extending perpendicularly to an intended direction of travel of the chair; the footrest having a geometric centerline, an outer edge, an inner edge substantially opposed to the outer edge, and side edges joining respective outer margins of the inner edge and outer edge; in which the inner edge of the footrest is shorter than the outer edge, and the footrest pivots with respect to the stairlift chair about a substantially vertical axis, the pivot position lying on both a central axis of the chair and a geometric centerline of the footrest.

17. The combination of claim 16, in which the pivot position lies closer to the inner edge of the footrest than to the outer edge.

18. The chair and footrest combination of claim 16, in combination with a stairlift.
